(19) United States
(12) Patent Application Publication
(10) Pub. No.: US 2023/0392064 A1
(43) Pub. Date: Dec. 7, 2023

(54) MULTIFUNCTIONAL TRACERS FOR ANALYSIS OF OILFIELDS

(71) Applicant: ENI S.P.A., Roma (IT)

(72) Inventors: Giuseppe MADDINELLI, San Donato Milanese (IT); Stefano CARMINATI, San Donato Milanese (IT); Davide MOSCATELLI, Arese (IT); Matteo MARALDI, Milano (IT)

(73) Assignee: ENI S.P.A., Roma (IT)

(21) Appl. No.: 18/250,045

(22) PCT Filed: Oct. 21, 2021
(86) PCT No.: PCT/IB2021/059708

§ 371 Date: Apr. 21, 2023

(30) Foreign Application Priority Data
Oct. 21, 2020 (IT) 102020000024871

(51) Int. Cl. C09K 8/035; C08F 220/38

(52) U.S. Cl. CPC C09K 8/035; C08F 220/387

(57) ABSTRACT

A new class of multifunctional tracers has been synthesised for use in the oil industry, specifically during waterflooding operations. They are used either in a traditional way (i.e., mapping the connections of oilfield selections) or to provide information on important physical-chemical parameters (such as oil content, temperature and rock permeability) useful for optimizing the oilfield management and subsequent improvement/increase in oil extraction. The multifunctional tracers have a polymer chain having a plurality of units different from one another and recurring along the chain and having respective specific functionalities. The units have at least a first rock-repulsive unit, which is configured to provide an effect of electrostatic repulsion towards rock, and at least a second detectable unit, which is configured to allow detectability of the tracer; and optionally at least a third unit, which is configured to detect a parameter or features of an oilfield, in particular oil saturation and temperature.

### CROSS-REFERENCE TO RELATED APPLICATIONS

This application claims priority from PCT Application No. PCT/1132021/059708, filed Oct. 21, 2021, which claims priority from Italian Patent Application No. 102020000024871 filed on Oct. 21, 2020, the entire disclosures of both of which are incorporated herein by reference.

### FIELD OF THE DISCLOSURE

The present disclosure relates to multifunctional tracers for acquiring structural and physical-chemical information on oilfields.

In particular, the present disclosure relates to a new class of multifunctional, water-soluble tracers that are introduced into aqueous solution during waterflooding operations for secondary oil recovery.

### DESCRIPTION OF THE RELATED ART

The use of such tracers makes it possible to map the oilfield in terms of preferential water paths and, simultaneously, to determine additional physical-chemical parameters of the oilfield such as the porosity of the rock system and the amount of residual oil in the formation. The joint information, acquired by using said tracers, is aimed at optimising the management of the oilfield thanks to the achievement of an exhaustive knowledge of the subsoil of interest with a view to increasing/improving oil extraction.

The use of tracers for mapping and the structural characterization of oilfields is well known.

In particular, chemical compounds such as fluorinated benzocarboxylic acids, ethanol, ethyl acetate and others, or radioactive compounds such as tritiated water (HTO), which are added in the waterflooding operations, are known to be used as tracers.

The structural characterization of the oilfield is obtained from a thorough knowledge of the configuration of the underground reservoir, in terms of interconnections between wells, flow directionality, dimension of each well and presence of barriers and anomalies.

Exploration of the complex configuration of the subsoil may be accomplished by means of a technique called inter-well technology, which involves analysing the timings and the characteristics of the chemical compounds introduced into the aqueous solutions, which are injected into the oilfield and then collected at the producing wells after passing through the extensive underground oilfield. Subsequently, these aqueous solutions are pre-treated, the chemical compounds (standard or radioactive) isolated and then subjected to instrumental analytical techniques such as, usually, mass spectrometry (SPE-118862-MS, SPE-184956-MS).

Recently, spectroscopic techniques have also been used to characterize the oilfields. In this regard, US6850317 describes the use of fluorescent species dissolved in aqueous solutions, the presence of which is detected by measuring their fluorescence by fluorimetry.

However, the known techniques mentioned here, as well as other similar ones, have certain limitations.

Firstly, the chemical compounds (including radioactive ones) introduced into aqueous solutions only allow to detect their presence and therefore to obtain structural information regarding the configuration of the underground reservoir. Furthermore, the typical detection technique of such chemical compounds, such as mass spectrometry, is not the most adequate analytical method to quantitatively analyse said chemical compounds due to its poor detection sensitivity towards this type of tracers, resulting in an approximate mapping of the oilfield. As a result, numerical modelling on the basis of incomplete experimental data leads to an inaccurate estimate of the capacities (quantity of barrels present and recoverable quantities) and possibly of the cost-effectiveness of the oil extraction process.

Secondly, the analysis of chemical compounds by mass spectrometry has drawbacks, starting with the need for a preliminary treatment of the aqueous solutions containing said chemical compounds. This process takes place in specialised laboratories that are often located geographically far from the oil fields. This implies logistical problems for the transport of samples from the recovery site to the analysis laboratories with the associated cost and time expenditure. Moreover, the use of radioactive chemical compounds as tracers in the aqueous solutions requires the implementation of special safety measures, which are applied for precautionary purposes.

### SUMMARY OF THE DISCLOSURE

Aim of the present disclosure is therefore to overcome the above-mentioned drawbacks of the known technique.

In particular, aim of the disclosure is to allow the acquisition of a wide range of information in addition to mapping the oilfield, so as to carry out, besides the structural analysis of the subsoil of interest, also the detection of physical-chemical parameters that contribute to a more detailed characterization of the oilfield.

In accordance with these aims, the present disclosure relates to a multifunctional tracer for analysing oilfields as defined in the appended claim 1.

The disclosure further relates to the use of said tracer in a method for analysing an oilfield, in particular for mapping and characterizing the oilfield, as defined in claim 17.

The disclosure also relates to a process for preparing tracers, as defined in claim 19.

Additional preferred characters of the disclosure are indicated in the dependent claims.

In summary, the disclosure provides a new class of polymeric tracers consisting of multiple units, formed by one or more monomers and that are different from each other, each having a selective functionality responsible for determining a specific physical-chemical parameter, and/or a particular interaction characteristic with the oilfield in which the tracer is used. The set of units gives a multifunctional character to the tracer of the disclosure, which may also be prepared with different, specially selected units, depending on the specific use of the tracer.

The disclosure makes it possible to acquire a plurality of information and consequently to achieve a higher level of exploratory knowledge of the oilfield leading to the realistic theoretical modelling thereof and a consequent reliable assessment of the amount of oil present in the oilfield.

In addition, the plurality of information is acquired through analytical methods that are more sensitive, quantitative and specific to the class of tracers under consideration.

In case new tracers have fluorescent units, the appropriate analytical technique for their detection, such as fluorescence spectroscopy, may be performed by a simple, commercial measuring instrument (fluorimeter) and may be carried out on-site as no pre-treatment of the aqueous solutions in dedicated laboratories is required. Said advantage allows for a less complex, and therefore less expensive analysis of the tracers, and the experimental data may be quickly available for processing with sophisticated algorithms to simulate oilfield capacities. Therefore, the drawbacks highlighted by the known technique and related, firstly, to the limited information (only of the structural features of the reservoir) acquired using chemical compounds introduced into aqueous solutions and, secondly, to the inadequate method for detecting such chemical compounds, are overcome by the present disclosure.

In a nutshell, the disclosure is characterized by the fact the new tracer is configured as a copolymer whose multifunctionality derives from specific monomers selected as reactants during the free radical polymerization reaction in solution. Each monomer having a specific functional group may be inserted during the synthesis step to increase the sensitivity of the copolymer towards a particular physical-chemical parameter. Furthermore, the characteristics of the tracer may be adjusted by varying the molar ratios between the different monomers that form the final copolymer and the molecular weight of the tracer itself.

This makes the tracers flexible and adaptable to the technical needs required by the specific scope of investigation in the oil field.

In more detail, the tracers in accordance with the disclosure are copolymers, preferably statistical (random) copolymers, in the chain of which different types of units having different functionalities are inserted.

In particular, the tracer of the disclosure comprises:
a unit that allows the tracer to have little interaction with the rocks with which it comes into contact in use;
a unit that allows a simple and reliable detection of the tracer, e.g. on the basis of the spectroscopic techniques or by mass spectrometry;
optionally, one or more units that allow to evaluate parameters or chemical-physical characteristics of the oilfield, such as saturation in the oil phase (through fat solubility measurements), temperature, or other.

In particular, little interaction with rocks is achieved by using monomers with hydrophilic and negative (negatively charged) functional groups, which give the polymer chain of the tracer adequate inertia towards rocks due to the effect of electrostatic repulsion. By way of example, the absence of interactions with rocks is due to a monomer such as sulfopropyl methacrylate potassium salt (SPMAK).

The detectability of the tracer is given by the insertion of a fluorescent monomer which may be easily identified with high reliability by fluorimetry (fluorescence analysis); or a monomer having a rare earth element (metal) detectable by mass spectrometry.

In particular, the detectability of the tracer is provided by fluorescein isothiocyanate (FITC), in case fluorimetry is used as the analytical method; or by a rare earth element, in particular a lanthanide such as for example europium or terbium, chelated with the ester of 1,4,7,10-tetraazacyclododecane-1,4,7,10-tetraacetic acid and N-hydroxysuccinimide (NHS) (DOTA-NHS-Tb or DOTA-NHS-Eu), in case the tracer analytical method is mass spectrometry. As is commonly acknowledged, the definition of rare earths includes lanthanides (also called lanthanoids), i.e. the elements with atomic numbers from 57 to 71 (from lanthanum to lutetium) in the periodic table, as well as scandium and yttrium. Rare earth elements are chemically similar and have similar properties; therefore, all rare earth elements are suitable for use in the present disclosure, since they are also fully equivalent from the point of view of detectability by mass spectrometry. However, it is advantageous to use europium (Eu) or terbium (Tb) because they are generally the least common in the oilfields.

The basic structure of the tracers of the disclosure, formed by rock-repulsive units and detectable units, allows the tracers to flow through the oilfield, without excessive interaction with the rocks, and to be easily and effectively detected.

The tracers of the disclosure may then optionally include other functional units capable of providing different information about the crossed oilfield.

In particular, the tracers of the disclosure may include units capable of detecting the distribution of the tracer in the oil phase.

The distribution of the tracer in the oil phase, adapted to study the saturation of the crude oil, is ensured by the addition of a lipophilic monomer, in particular having a variable degree of lipophilicity.

In particular, three monomers with increasing degrees of lipophilicity were selected: hydroxyethylmethacrylate (HEMA), methylmethacrylate (MMA), buthylmethacrylate (BMA).

The addition of thermolabile groups in the polymer chain then optionally allows the temperature of the formation crossed by the tracer to be detected. For example, the tracers of the disclosure include molecules comprising one or more functional groups which are sensitive to changes in temperature: the decomposition of the thermolabile group due to a variation in temperature causes a consequent change in the structure of the tracer molecule and thus a variation in the signal of the detectable unit. Suitable thermolabile groups are, for example, nitrile or peroxide groups, which are particularly suitable given the usual temperature ranges in the oilfields.

### BRIEF DESCRIPTION OF THE DRAWINGS

Further features and advantages of the present disclosure will become clear from the description of the following non-limiting embodiments, with reference to the figures of the accompanying drawings, wherein:

FIG. 1 shows a general formula of a tracer in accordance with a first embodiment of the disclosure;

FIG. 2 shows a general formula of a tracer in accordance with a second embodiment of the disclosure;

FIG. 3 schematically represents a step of a process for synthesizing a tracer in accordance with the disclosure;

FIGS. 4 and 5 schematically represent respective steps of a variant of the process for synthesizing the tracer of the disclosure;

FIG. 6 schematically represents a further step of the process for synthesizing the tracer of the disclosure;

FIG. 7 schematically represents a further step of the process for synthesizing the tracer of the disclosure, in a different embodiment;

FIG. 8 is a graph showing the trend of the molecular weight of tracers in accordance with the disclosure as the percentage of chain transfer agent used in the polymerization step varies;

FIG. 9 is a graph showing the results of adsorption testing on tracers of the disclosure;

FIG. 10 is a graph showing the results of fluorescence emission testing of tracers according to the disclosure;

FIG. 11 shows three graphs with results of oil phase distribution tests of tracers in accordance with the disclosure;

FIG. 12 shows data for a comparison between fluorescence signals emitted by a reference molecule and by tracers of the disclosure;

FIG. 13 shows the results of elution tests carried out on tracers of the disclosure;

FIG. 14 shows a general formula of a tracer in accordance with a further embodiment of the disclosure, comprising also thermolabile groups;

FIGS. 15 to 17 schematically represent respective steps of a process for synthesizing the tracer of FIG. 14 and more precisely: a first step of functionalizing the thermolabile group (FIG. 15); a second functionalizing step with the addition of a detectable unit (FIG. 16); a final step of polymerization of the tracer (FIG. 17).

### DETAILED DESCRIPTION OF THE DISCLOSURE

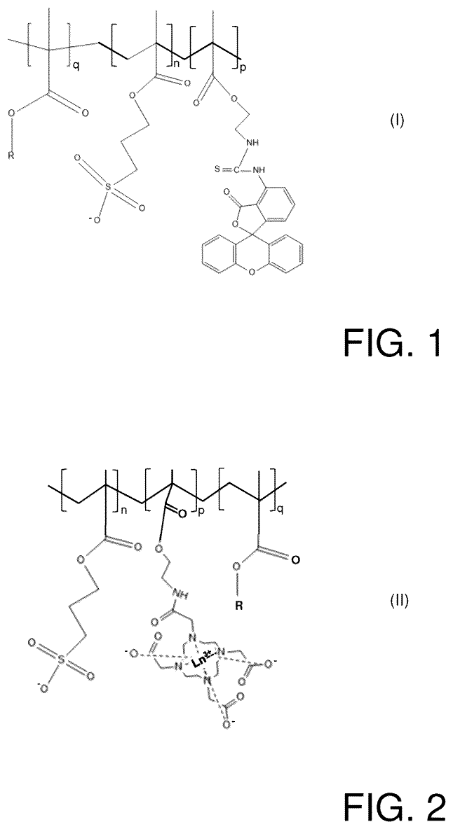

FIG. 1 shows the general formula (I) of a tracer according to a first embodiment of the disclosure, detectable by fluorimetry (fluorescence spectroscopy).

The tracer is a copolymer having a chain made up of different types of monomer units, preferably inserted in a statistical manner along the chain (statistical or random copolymer) and precisely:
a hydrophilic and negative monomer to give the tracer properties of repulsion towards rocks, in particular sulfopropyl methacrylate potassium salt (SPMAK);
a detectable monomer, in particular a fluorescent monomer (detectable by fluorimetry or fluorescence spectroscopy) such as fluorescein isothiocyanate (FITC) or a monomer detectable by mass spectrometry and containing for example a rare earth element (Eu or Tb) chelated with the ester of 1,4,7,10-tetraazacyclododecane-1,4,7,10-tetraacetic acid and N-hydroxysuccinimide (NHS) (DOTA-NHS-Tb or DOTA-NHS-Eu);
a lipophilic monomer that allows to evaluate parameters and/or chemical/physical characteristics of the oilfield, e.g. the distribution of the tracer in the oil phase, for example selected from: hydroxyethylmethacrylate (HEMA), methylmethacrylate (MMA), buthylmethacrylate (BMA).

For example, FIG. 1 schematically shows a tracer of general formula (I) and containing: SPMAK as a hydrophilic and negative rock-repulsive monomer; fluorescein isothiocyanate (FITC) functionalized with 2-aminoethyl methacrylate (AEMA) as a fluorescently detectable monomer (properly, co-monomer) (AEMA-FITC co-monomer), detectable by fluorimetry; a lipophilic monomer for the characterization of the distribution in the oil phase selected from hydroxyethylmethacrylate (HEMA), methylmethacrylate (MMA), buthylmethacrylate (BMA).

With reference to the general formula (I) shown in FIG. 1:
q is the number of lipophilic units
n is the number of hydrophilic and negative units
p is the number of fluorescent units
R is selected from CH3-, CH2CH2CH2CH3-, CH2CH2OH—

The numerical values of n, q, p are selected as a function of the characteristics of the polymer. By selecting the molar ratios among the various monomers, these values may be varied according to the application.

For example:
q is ranging from 0.003 to 10
n is ranging from 20 to 5000
p is ranging from 0.1 to 20
(here and in the following, the number of units is expressed in statistical terms: as a result of the polymerization, polymer molecules of different lengths and with different numbers of the various units and thus different p, q, n values are formed; the indicated values are statistical average values of the polymer comprising different molecules with different p, q, n values).

FIG. 2 schematically shows a tracer of general formula (II) and containing: SPMAK as a hydrophilic and negative rock-repulsive monomer; europium or terbium chelated with the functionalized chelating molecule AEMA-DOTA as a detectable co-monomer (AEMADOTA-Eu co-monomer, or AEMADOTA-Tb co-monomer), detectable by mass spectrometry; a lipophilic monomer for the characterization of the distribution in the oil phase selected from hydroxyethylmethacrylate (HEMA), methylmethacrylate (MMA), buthylmethacrylate (BMA).

With reference to the general formula (II) shown in FIG. 2:
q is the number of lipophilic units
n is the number of hydrophilic and negative units
p is the number of detectable units containing Eu or Tb
Ln is a rare earth element (selected from yttrium, scandium and lanthanides), preferably a lanthanide and more preferably europium (Eu) or terbium (Tb).

The numerical values of n, p, q are selected as a function of the characteristics of the polymer. By selecting the molar ratios among the various monomers, these values may be varied according to the application.

For example:
n is ranging from 20 to 5000
q is ranging from 0.003 to 10
p is ranging from 0.1 to 20

In other embodiments, the tracers of general formula (I) or (II) may also not include any lipophilic units for the characterization of the distribution in the oil phase and thus be formed only by rock-repulsive units and detectable units.

In other embodiments, the tracers of general formula (I) or (II) include, in addition to the rock-repulsive units and the detectable units and alternatively or together with the lipophilic units, other types of functional units that can provide information on other chemical-physical parameters.

In particular, the polymer chain of the tracers may include molecules containing thermolabile groups to enable the temperature of the crossed formation to be detected. The tracers of the disclosure thus comprise units, arranged along the chain or carried by other functional units (which are in this case functionalized with suitable groups) having one or more functional groups which are sensitive to changes in temperature, such as nitrile or peroxide groups. The choice of the thermolabile molecules used is made by selecting molecules with decomposition temperatures of the thermolabile groups in line with the expected temperature ranges within the oilfields.

In preferred embodiments, the thermolabile groups are associated with fluorescent monomers (detectable units): the polymer chain of the tracers thus has fluorescent monomers functionalized with molecules containing thermolabile groups, in particular nitrile or peroxide groups.

Further examples of embodiments of the disclosure, either as regards the preparation of the tracers or the characterization thereof, are described in detail hereinbelow.

### Examples—Preparation of the Tracers

As highlighted above, the tracers of the disclosure are polymers formed by different units having respective functionalities.

The synthesis of a tracer in accordance with the disclosure is carried out following successive reaction steps starting from the synthesis of the monomer responsible for the detectability of the tracer, such as a fluorescent monomer or a monomer containing the rare earth element (e.g., europium or terbium), and closing with the polymerization reaction starting from the various monomers.

The method for preparing the detectable monomer (which gives the tracer the characteristic of being detected by fluorescence analysis or mass spectrometry, respectively) is described in detail hereinbelow. The other monomers included in the tracers of the disclosure are commercially available and in any case of known preparation and therefore require no further detailed description.

### 1) Synthesis of the Detectable Co-Monomer

### a) Synthesis of the Fluorescent Co-Monomer

In order to copolymerize the fluorescent monomer with other specific monomers, it is necessary to functionalize the fluorescent monomer, e.g. fluorescein isothiocyanate (FITC), with a hydrophilic compound having a vinyl group capable of binding to the other monomer units by radical polymerization.

The hydrophilic compound selected to functionalize fluorescein isothiocyanate (FITC) is 2-aminoethyl methacrylate (AEMA).

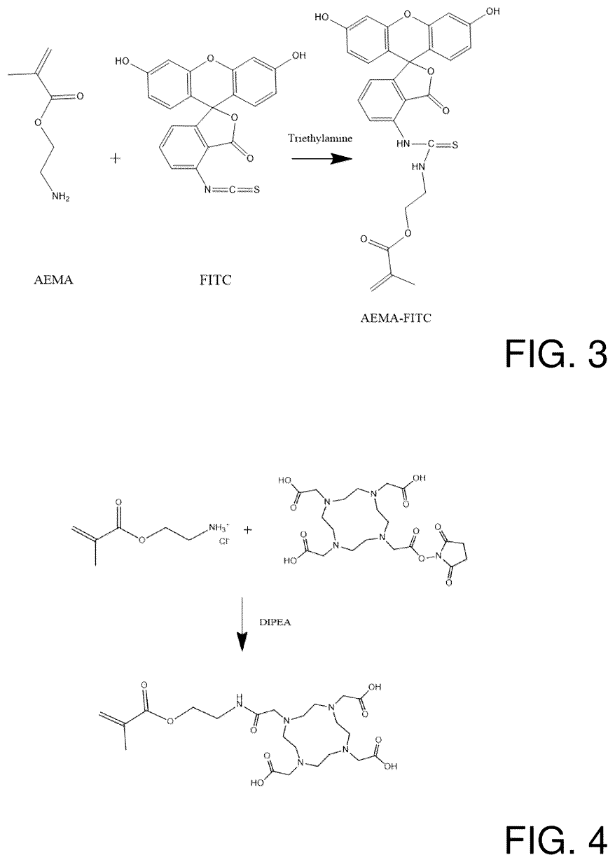

Functionalization of FITC with AEMA, as shown in FIG. 3, takes place thanks to the formation of the thio-urea bond between the amino group of AEMA and the isothiocyanate group of FITC, thus obtaining the AEMA-FITC co-monomer.

The advantage of selecting AEMA over other reagents is represented by the stability of the thio-urea bond either at high temperatures or in the presence of water, both conditions present in the oilfields.

By way of example, the reaction was carried out for 24 hours at room temperature under stirring using N,N-dimethylformamide as solvent and triethylamine as catalyst.

100 mg FITC (1.1 mass equivalent), 39 mg AEMA and 30 mg triethylamine were dissolved in 10 ml N,N-dimethylformamide.

Subsequently, this solution was poured into a laboratory flask with a capacity of 25 ml and containing a magnetic stirrer. The reaction continued overnight at room temperature.

### b) Synthesis of the Co-Monomer Containing a Rare Earth Element

As regards the detection by mass spectrometry, some atoms belonging to the class of rare earth metals, specifically europium or terbium, were selected as the constituent elements of the detectable monomer.

The selection of europium or terbium among the rare earth metals is based on their stability, high reactivity in the chelation process and excellent detectability by mass spectrometry over a wide range of concentrations.

The synthesis of the monomer takes place in two steps.

The first step involves functionalizing a chelating molecule with a methacrylate molecule so that the resulting co-monomer can actively take part in the subsequent radical polymerization reaction.

For example, as shown in FIG. 4, the methacrylate molecule is 2-aminoethyl methacrylate (AEMA) and the chelating molecule is the ester of 1,4,7,10-tetrazacyclodecane-1,4,7,10-tetraacetic acid and NHS (DOTA-NHS).

The functionalization step closes with formation of an amide bond between 2-aminoethyl methacrylate (AEMA) and the chelating molecule ester of 1,4,7,10-tetrazacyclodecane-1,4,7,10-tetraacetic acid and NHS (DOTA-NHS). The reaction is carried out at room temperature using N,N-dimethylformamide as a solvent and N,N-diisopropylethylamine (DIPEA) as a binding agent, as shown in FIG. 4.

By way of example, 275 mg of DOTA-NHS (1.5 mass equivalent), 39 g of AEMA and 30 g of N,N-diisopropylethylamine were dissolved in 4 ml dimethylformamide. Subsequently, this solution was poured into a laboratory flask with a capacity of 25 ml and containing a magnetic stirrer. The reaction continued overnight at room temperature. At the end of the reaction, the product was purified by precipitation in dimethyl ester and then separated from the solvent by filtration.

The second step of the synthesis involves protecting the rare earth element so as to ensure repulsion towards the rock during contact and thus avoid exchanges with other positive ions present or adsorbed on the negative charges of the rock.

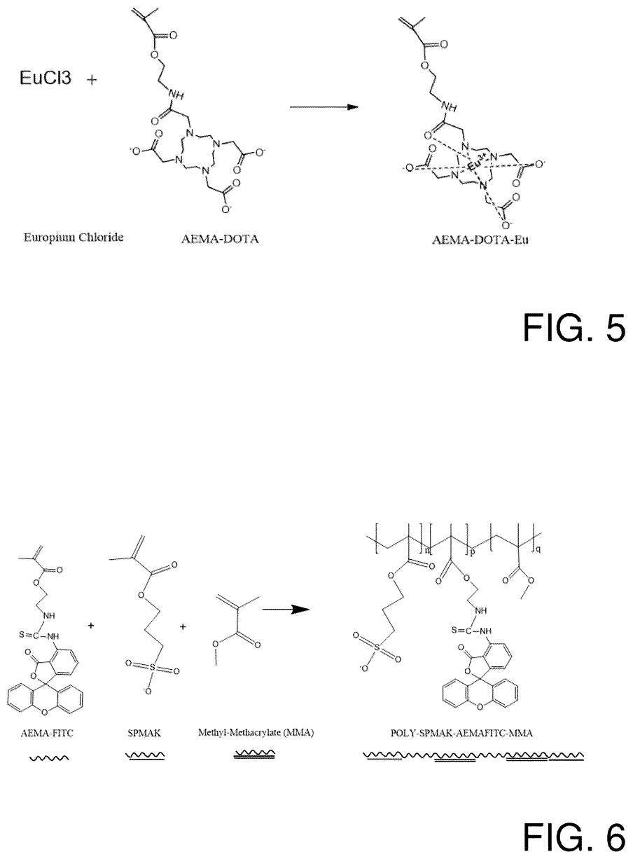

The solution adopted for this purpose involves chelating the rare earth element (europium or terbium) with the functionalized chelating molecule (DOTA) (AEMA-DOTA) as shown in FIG. 5 (chelation of europium).

The second reaction step was carried out at 50° C. for 4 hours in a solvent consisting of an acetic acid/acetate buffer solution maintaining a pH equivalent to 5.5.

By way of example, 91 mg of AEMA-DOTA (1.5 mass equivalent) and a rare earth element (europium or terbium) in chloride form were dissolved in 1.4 ml of 0.1 M acetic acid/acetate buffer solution at a pH of 6.5. Subsequently, this solution was poured into a laboratory flask with a capacity of 10 ml and containing a magnetic stirrer.

The reaction continued overnight at 50° C.

### 2) Copolymerization of all Monomers by Free Radical Polymerization

The tracers of the disclosure are random copolymers synthesized by free radical polymerization. Copolymerization by free radical polymerization is therefore the final step in the process for synthesizing the tracers. In this step, polymerization takes place between the monomers or co-monomers (i.e. the functionalized monomers) capable of providing all the functionalities to the final product.

The characteristics of the polymer (tracer) may be adjusted by varying the molar ratios between the different molecules belonging to the material. In particular, in the tracer, the absence of interaction with the rocks is due to the negative and hydrophilic co-monomer, the controllable lipophilicity is due to the amount and type of the lipophilic co-monomer, and the detectability is provided by the fluorescent molecules (detectable by fluorimetry) or by monomers containing rare earth metals (detectable by mass spectrometry).

As already indicated, the hydrophilic and negative co-monomer is for example the 3-sulfopropyl methacrylate potassium salt (SPMAK); the lipophilic co-monomer is for example methylmethacrylate (MMA), hydroxyethylmethacrylate (HEMA) or butylmethacrylate (BMA); the detectable co-monomer is for example fluorescein isothiocyanate (FITC) in case of detection by fluorimetry, and terbium or europium chelated with the ester of 1,4,7,10-tetraazacyclododecane-1,4,7,10-tetraacetic acid and N-hydroxysuccinimide (NHS) (DOTA-NHS-Tb or DOTA-NHS-Eu) in case of detection by mass spectrometry.

The molecular weight of the final polymer may be modified by adding a variable amount of a chain transfer agent, e.g. 3-mercaptopropionic acid, to the polymerization reaction in order to decrease the length of the polymer chain and thus the molecular weight thereof.

Preferably, but not necessarily, the tracers have an average molecular weight ranging between 5 kDa and 1300 kDa. However, it is understood that the molecular weight may be different, also depending on specific applications.

In preferred embodiments, the tracers contain from 1 to 30% by weight of hydrophilic and negative monomer units; and have a molar ratio between the various units, in particular molar ratio between negative hydrophilic monomer and detectable monomer and molar ratio between negative hydrophilic monomer and lipophilic monomer, which is variable according to the application.

It is important to note that the molar ratios between the various units may be varied to give the tracers the most appropriate properties for specific applications.

In particular, the molar ratios will differ depending on the type of lipophilic monomer selected and the desired distribution.

By way of example only, the molar ratio of negative hydrophilic monomer (e.g. SPMAK) to detectable monomer (e.g. FITC) is ranging from 50 to 500; the molar ratio of negative hydrophilic monomer (e.g. SPMAK) to lipophilic monomer (HEMA, BMA, MMA) is ranging from 10 to 1000.

It is understood that these values are given by way of example only and do not exclude other choices.

Similarly, the weight percentage of hydrophilic monomer in solution may also be varied according to need.

By way of example, the hydrophilic and negative monomer (SPMAK), the lipophilic monomer (HEMA, MMA or BMA) and the detectable co-monomer (AEMA-FITC or AEMA-DOTA-Eu) were polymerized at 65° C. for 24 hours under an inert atmosphere using 4,4′-azobis(4-cyanovaleric acid) as an initiator.

In the case of the fluorescent co-monomer (SPMAK), the reaction is shown in FIG. 6 (synthesis of the fluorescent copolymer poly-SPMAK-AEMAFITC-MMA).

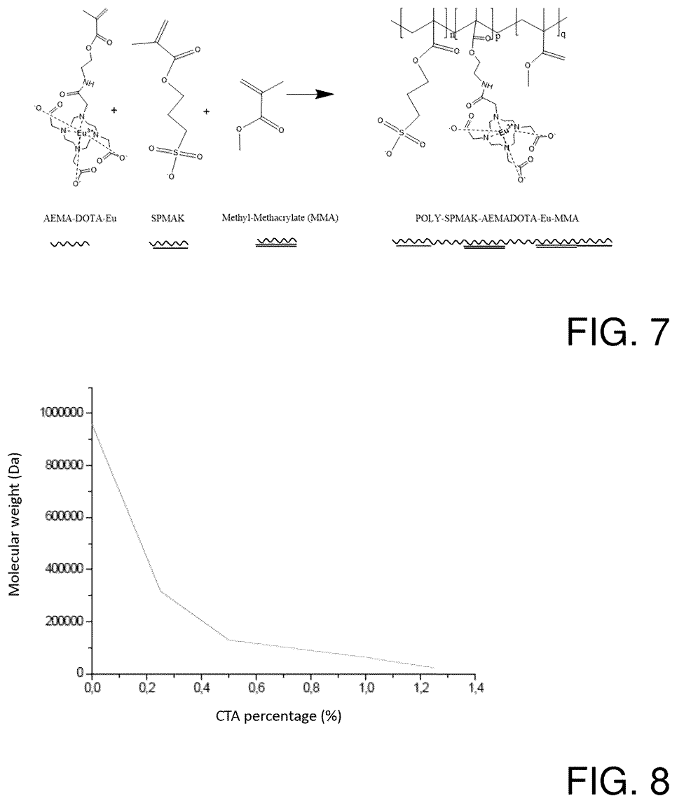

Instead, in the case of a co-monomer containing a rare earth element (specifically europium), which can be detected by mass spectrometry, the reaction is shown in FIG. 7 (synthesis of the poly-SPMAK-AEMADOTA-Eu-MMA copolymer).

In order to modulate the lipophilicity of the tracer, the molar ratio between the negative and hydrophilic monomer (SPMAK) and the lipophilic monomer (HEMA or MMA or BMA) may be varied.

After polymerization, the conversion of the copolymer is controlled by ¹H-NMR. For all synthesized tracers, a conversion of the monomers into copolymers between 94% and 99% was achieved.

By way of example, for the synthesis of the SPMAK-AEMAFITC-MMA copolymer (molar ratio of SPMAK to MMA equivalent to 1300), 45.8 mg of MMA, 2249.6 mg of SPMAK and 0.2 ml of AEMA-FITC solution were introduced into a 50 ml laboratory flask with a magnetic stirrer. Subsequently, 1 ml of ethanol and 14 ml of water were added and the flask was closed with a rubber stopper. The mixture was purged with nitrogen for 20 minutes to remove the oxygen present in the laboratory flask. Then, the flask, with a magnetic stirrer, was inserted in an oil bath preheated to 65° C. Polymerization was carried out for 24 hours. Once polymerization was complete, purification of the product was carried out by dialysis in water for 48 hours so as to remove all unreacted monomer or co-monomer.

After dialysis, the polymer was recovered and the absence of residual monomer was verified by ¹H-NMR.

### Examples—Characterization of the Tracers

The following are examples of tracer characterization of the disclosure, which highlight in particular how it is possible to optimize the various parameters and the specific functionalities of the tracers that affect the final performance.

Study of the Optimal Amount of SPMAK within the Copolymer

In order to determine the optimal amount of the negative and hydrophilic monomer, SPMAK, in the tracer, three copolymers (Poly-SPMAK-AEMAFITC) were analyzed with different weight percentages, in the range from 2% to 10%, of SPMAK in the reaction solution, keeping the amount of the co-monomer (AEMAFITC) constant.

When varying the weight percentage of SPMAK in the reaction, Table 1 shows the molecular weight (Mw) of the three final copolymers analyzed by gel permeation chromatography (GPC), the percentage of the polymerization conversion analyzed by ¹H-NMR and the percentage of the relative adsorption obtained by testing the variation in fluorescence emission of the tracer before and after contact with Berea sandstone following a Core-Flooding Test procedure.

Berea, according to the Core-Flooding Test, is a sandy material with characteristics similar to the rocks found in most oilfields. Moreover, a sample of Berea represents the best porous soil matrix model. As regards the Core-Flooding Test, this type of test is used to evaluate the capabilities of the new tracer products (e.g. Poly SPMAK-AEMAFITC-HEMA) in porous media under residual oil saturation conditions.

TABLE 1
molecular weights and conversions as the percentage by
weight of SPMAK varies in the polymerization reaction

| | Mw | Conversion | Relative |
|---|---|---|---|
| Materials | (Da) | (%) | adsorption (%) |
| 2% Poly SPMAK- | 112576 | 99.8 | 2 |
| AEMAFITC | | | |
| 5% Poly SPMAK- | 1204298 | 95.7 | 8.6 |
| AEMAFITC | | | |
| 10% Poly SPMAK- | 1302586 | 94.9 | 10.1 |
| AEMAFITC | | | |

As shown in Table 1, the copolymer characterized by the lower percentage of SPMAK (2%) and therefore by a lower ratio between SPMAK and AEMAFITC appears to adsorb less on the rock with a relative adsorption of 2%, and therefore this optimal amount of SPMAK was set for all subsequent analyses.

Effect of the Molecular Weight of the Final Copolymer on the Adsorption of the Tracer on the Rock

As regards the study on the influence of the molecular weight of the copolymer on adsorption, a library of tracers synthesized each with a different percentage of chain transfer agent (from 0 to 1.25% with respect to the monomer) was created. In fact, the molecular weight of the final copolymer may be modified by adding a variable amount of chain transfer agent (e.g. 3-mercaptopropionic acid) to the reaction in order to decrease the length of the polymer chain and thus the molecular weight.

The trend of the molecular weight of the synthesized tracers (with detectable fluorescent monomer) as the percentage of chain transfer agent, investigated by GPC, varies, is shown in FIG. 8.

Subsequently, the adsorption test of these tracers was carried out on the Berea. The trend of the relationship between the relative adsorption of the copolymer before and after contact with Berea is shown in FIG. 9, which shows the variation in the adsorption of the Poly-SPMAK-AEMAFITC tracers as the molecular weight of the polymer varies.

As can be seen from FIG. 9, the synthesized tracers show a good capability to be inert in contact with the rock only for very high or very low molecular weights. The fact that greater functionality of the copolymer only occurs at the extremes of the molecular weight range is mainly due to two factors: at high molecular weights, the tracer experiences a “size exclusion” phenomenon in the system, which consists in the fact that it is unable to permeate into the smaller pores, thus following the main conduits and limiting its contact with the rock due to the less tortuousness of its path; whereas, for low molecular weights, the Brownian motion and consequently the diffusivity of the copolymer in the smaller pores of the Berea increases; this greater mobility of the tracers combined with the overall negative charge capable of creating a repulsion towards the rock is able to effectively avoid adsorption on the Berea. For this reason, only tracers without chain transfer agent (therefore high molecular weight copolymers) or tracers with chain transfer agent equal to 1.25% by weight (therefore low molecular weight copolymers) are used in further optimizations.

Analysis of the Type and Amount of Lipophilic Molecules to Evaluate the Adsorption Effect Thereof on the Rock

The function of the lipophilic co-monomer is to modify the lipophilicity of the polymeric tracer as a whole and to allow a greater distribution between water and oil, so as to provide information on the amount of oil present in the oilfield.

Different types of lipophilic monomers were selected to modulate the tracer distribution as required. In particular, three molecules with an increasing degree of lipophilicity and with a methacrylate group capable of polymerizing via free radical polymerization were selected: hydroxyethylmethacrylate (HEMA), methylmethacrylate (MMA) and butylmethacrylate (BMA).

In order to be able to analyse the effect of either the type or the amount of lipophilic monomer on the functionality of the tracer, in particular as regards its capability to provide information on the amount of oil present in the oilfield, a library of copolymers characterized by a different ratio of SPMAK to lipophilic monomer was synthesized for each of the three selected lipophilic molecules (MMA, BMA and HEMA), either with high or low molecular weight.

After verifying by ¹H-NMR that the addition of the lipophilic monomer does not affect the high conversions of the polymerizations, the behaviour of the different monomers towards the rock was tested.

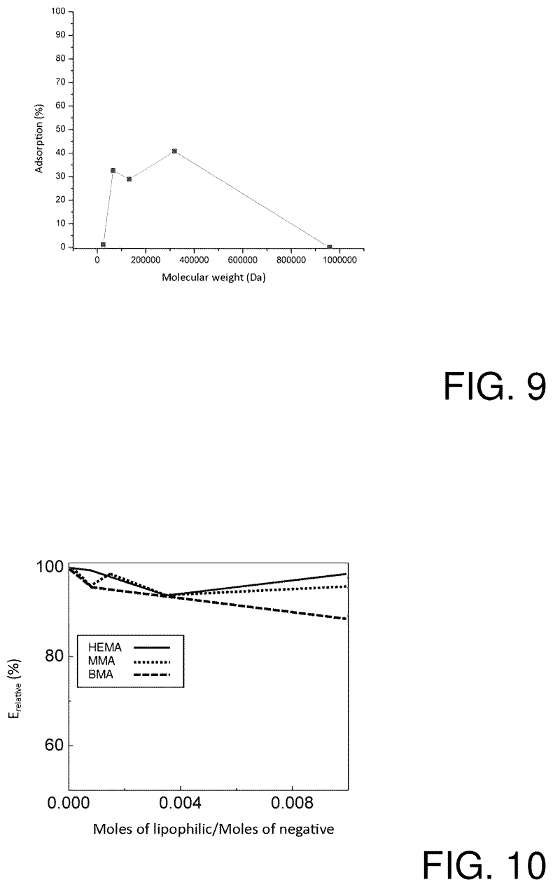

FIG. 10 shows the percentage trend of the fluorescence emission ratio before and after contact with Berea as the ratio between the moles of lipophilic monomer and SPMAK (negative monomer) in the composition of tracers for the different types of lipophilic molecules (MMA, BMA and HEMA) varies.

From FIG. 10 it can be seen that the presence of a lipophilic monomer does not affect the adsorption of the tracers on the Berea for low amounts of lipophilic monomer. However, as the lipophilicity of the monomer itself increases (from HEMA to MMA and ending with BMA) and the amount of the lipophilic molecule in the polymer chain increases, the polymer tends to exhibit an adsorption phenomenon that can become non-negligible, thus imposing a maximum value of lipophilicity within the tracer.

However, it was found that for the values tested (i.e. a range from 100 to 2500 as molar ratio values between negative hydrophilic monomer and lipophilic monomer), only in the case of butylmethacrylate (a more lipophilic monomer) the limit value for a negligible adsorption is a molar ratio between hydrophilic and negative monomer (SPAK) and lipophilic monomer (BMA) equal to 200. While for the other lipophilic monomers the adsorption on the rock is negligible at all tested values.

Capability of the Tracers to Distribute in an Oil Phase

As regards the evaluation of the capability of the tracers relative to their distribution in an oil phase, tests were carried out for all synthesized fluorescence-based copolymers. The method consists in mixing the tracer solution in aqueous phase added in a separatory funnel with the same volume of Dectol (mixture of Decane and Toluene in a 50/50 w/w ratio). Following vigorous stirring to maximise mixing, the solutions were demixed, the aqueous phase was recovered and a thermo-gravimetric analysis was performed before and after the test. The distribution was calculated using the copolymer distribution coefficient (K_{oil/water}) defined as:

$${K}_{oil / water} = \frac{{C}_{pre - distribution} - {C}_{in water post - distribution}}{{C}_{in water post - distribution}}$$

in which:
C_{pre-distribution} is the concentration of polymer in the solution before the distribution test;
C_{in water post-distribution} is the concentration of polymer in the aqueous phase after the distribution test.

For high molecular weight copolymers, the results obtained are shown in FIG. 11. In particular, FIG. 11 shows the trend of the distribution coefficient K ou/water of the polymer as a function of the ratio between the moles of lipophilic monomer and the moles of SPMAK in the polymer chain for MMA (top left), BMA (top right) and HEMA (bottom centre).

The results obtained show that the technology adopted makes it possible to precisely and effectively modulate the distribution of the polymers between the aqueous phase and the oil phases. In fact, for all lipophilic molecules tested there is an increase in the distribution in Dectol as the moles of the lipophilic molecules present in the tracer increase, as expected. Furthermore, by varying the type of molecule, a very wide range of distribution coefficient values can be covered, thus allowing tracers to be obtained that can potentially provide elution times that can be adapted to the different needs.

This behaviour was also confirmed for low molecular weight fluorescent copolymers, demonstrating the versatility of the technology.

Adsorption test on the rocks of tracers containing fluorescent monomer to detect the presence of the tracer

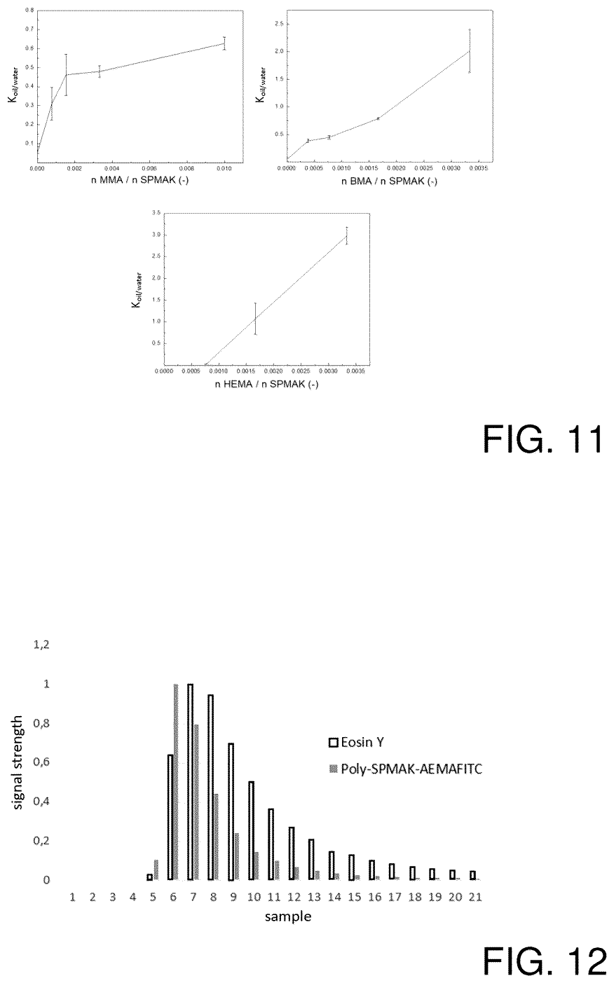

The actual applicability of the tracers containing a fluorescent monomer was confirmed by experiments carried out following the procedure known as the Core-Flooding Test, in order to simulate the elution of the tracer in the oilfield. The copolymer was completely eluted and the elution time was comparable to that of Eosin Y, a small fluorescent molecule that is very effective as a tracer, as shown in FIG. 12. FIG. 12 shows the comparison between the fluorescence signals emitted by the reference Eosin Y molecule and the Poly SPMAK-AEMAFITC copolymer when varying the number of elution samples.

The polymer tested (Poly SPMAK-AEMAFITC) was synthesized without the presence of the lipophilic monomer in order to evaluate only the behaviour of the polymer with the negative rocks and the aqueous phase.

Adsorption Test on the Rock of Tracers Containing Europium in the Monomer Responsible for Tracer Availability

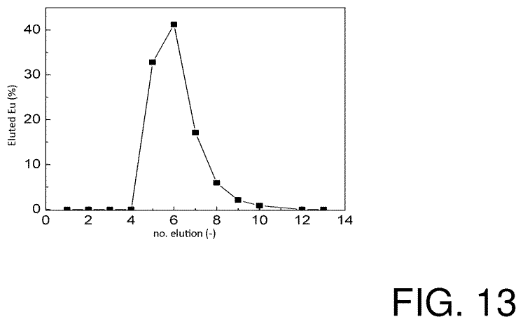

Tracers containing, as a detectable monomer, a monomer containing a rare earth element, in particular europium, were tested by transit through a section (“core”) of Berea. The results, obtained using an experimental method similar to that described for testing fluorescent copolymers, are shown in FIG. 13.

FIG. 13 shows the europium elution curve in a section of Berea expressed as the percentage of europium eluted with respect to the total as the number of samples eluted varies.

As can be observed from FIG. 13, europium (Eu) is eluted efficiently and rapidly, in fact the elution times are comparable with those of the Nal reference currently used. Furthermore, by integrating the area under the curve, it is obtained that the overall amount of eluted europium is comparable to the amount of europium injected into the aqueous solution, confirming the absence of adsorption towards Berea.

All experimental tests thus confirm that the tracers of the disclosure are fully efficient in meeting the two main conditions required by the application: repulsion towards rock and excellent detectability for a wide range of concentrations with simple methods.

### MORE EXAMPLES

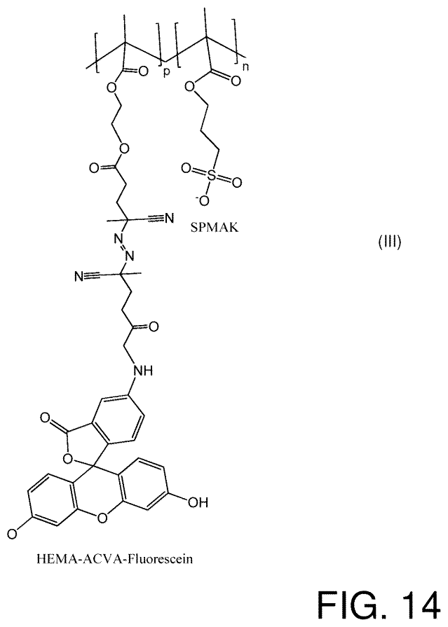

FIG. 14 shows the general formula (III) of a tracer according to a further embodiment of the disclosure, with thermolabile units for detecting the temperature of the crossed formation.

The tracer is again a copolymer (preferably a statistical or random copolymer) with a chain formed by:
hydrophilic and negative rock-repulsive units, in particular sulfopropyl methacrylate potassium salt (SPMAK);
detectable units, in particular fluorescent units (detectable by fluorimetry or fluorescence spectroscopy) comprising fluorescein;
thermolabile units for temperature detection, particularly associated with the fluorescent units.

In this case, the fluorescent units are functionalized with nitrile groups, in this case carried by a 4,4′-azobis(4-cyanopentanoic acid) molecule, also known as 4,4′-azobis(4-cyanovaleric acid (ACVA), which define the temperature detection units.

In addition, the detectable (fluorescent) unit is also functionalized with a lipophilic monomer, in particular HEMA.

The tracer of general formula (III) therefore contains SPMAK as a hydrophilic and negative rock-repulsive monomer; and HEMA-ACVA-functionalized fluorescein as a detectable monomer integrating the characterization function of the crossed formation.

Also in the general formula (III):
n is the number of hydrophilic and negative units (e.g. ranging from 20 to 5000)
p is the number of fluorescent units (e.g. ranging from 0.1 to 20)

The numerical values of n, p are always selected as a function of the characteristics of the polymer and may be varied by modifying the molar ratios between the various monomers.

The synthesis of the polymer of general formula (III) may be carried out in much the same way as described above.

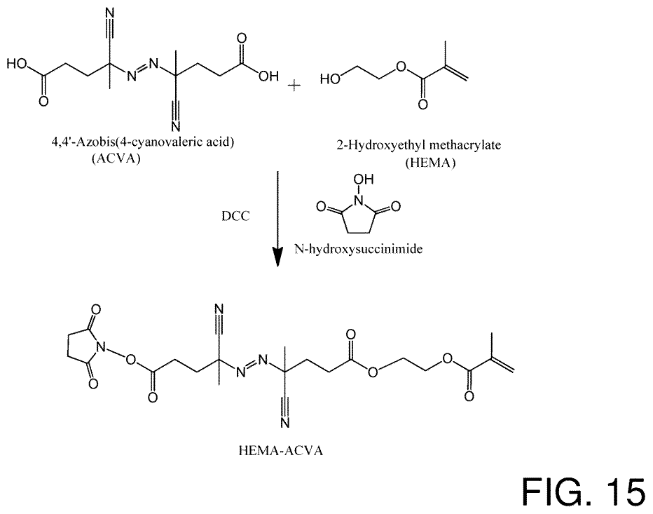

In this case, prior to the copolymerization reaction of the various monomers, a first step of functionalization of the thermolabile group (specifically, nitrile group carried by ACVA) with HEMA is carried out to provide the double bond that guarantees the capability to polymerize, as shown in FIG. 15, resulting in a thermolabile HEMA-ACVA monomer. The reaction is advantageously carried out in the usual way in the presence of DCC (N,N′-dicyclohexyl carbodiimide) and N-hydroxysuccinimide.

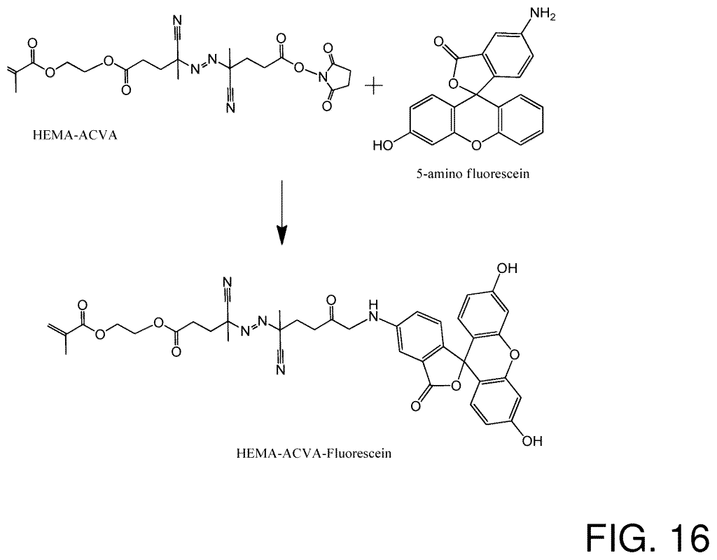

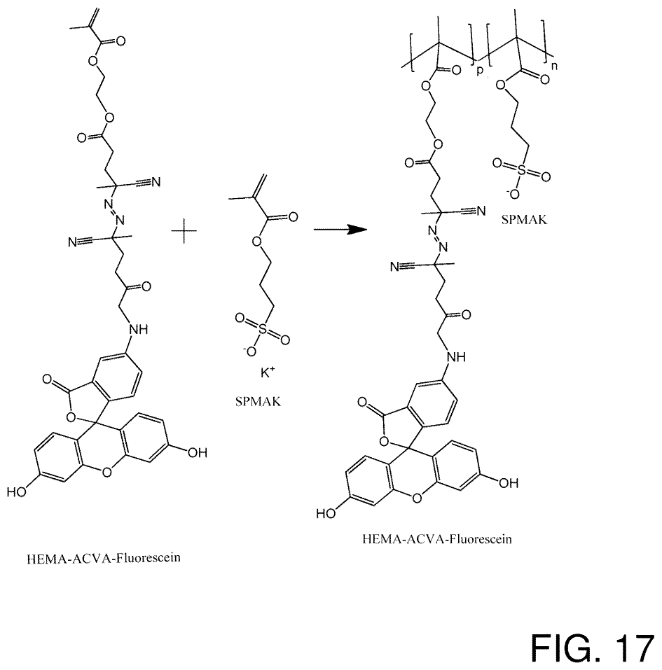

A second functionalization step follows with the addition of fluorescein to the thermolabile monomer to ensure the detection by fluorimetry, as shown in FIG. 16. Finally, the various monomers are polymerized to form the tracer of general formula (III), in particular by free radical polymerization.

Tracers of general formula (III) were prepared with different chain lengths and different numbers of the various units, as well as containing other thermolabile groups (e.g. peroxides) instead of the nitrile groups.

Further tracers were prepared by combining the various units described in the previous examples in a different way, as well as by varying the relative amounts of the various units and of the different monomers.

All the prepared tracers were then characterized and tested as described above and were found to be fully efficient in the specific application for which they are intended, having the expected characteristics of repulsion towards the rock, excellent detectability and the capability of providing additional information (oil saturation and/or temperature) on the crossed formations.

1. Multifunctional tracer for analysis of oilfields, the tracer having a polymer chain comprising a plurality of units different from one another and recurring along the chain and having respective specific functionalities, the units comprising at least a first rock-repulsive unit configured to provide an effect of electrostatic repulsion towards rock, and at least a second detectable unit configured to allow detectability of the tracer s and optionally at least a third unit configured to detect a parameter or features of the oilfield.

2. A tracer according to claim 1, wherein the first unit comprises a hydrophilic and negative monomer.

3. A tracer according to claim 1, wherein the first unit contains sulfopropyl methacrylate potassium salt (SPMAK).

4. A tracer according to claim 1, wherein the second unit comprises a monomer containing a fluorescent molecule so that the tracer is detectable by fluorescence spectroscopy.

5. A tracer according to claim 4, wherein the fluorescent molecule is fluorescein isothiocyanate (FITC).

6. A tracer according to claim 5, wherein the fluorescent molecule is fluorescein isothiocyanate (FITC) functionalized with 2-aminoethyl methacrylate (AEMA).

7. A tracer according to claim 1, wherein the second unit comprises a monomer containing a rare earth element selected from the group consisting of lanthanides, scandium and yttrium so & that the tracer is detectable by mass spectroscopy.

8. A tracer according to claim 7, wherein the rare earth element is europium or terbium.

9. A tracer according to claim 7, wherein the rare earth element is chelated with the ester of 1,4,7,10-tetraazacyclododecane-1,4,7,10-tetraacetic acid and N-hydroxysuccinimide (NHS).

10. A tracer according to claim 1, comprising at least a third unit configured to detect oil saturation and/or at least a fourth unit configured to detect temperature.

11. A tracer according to claim 10, wherein the third unit comprises a lipophilic monomer for detecting oil saturation.

12. A tracer according to claim 11, wherein the third unit comprises a monomer selected from the group consisting of hydroxyethylmethacrylate (HEMA), methylmethacrylate (MMA), and buthylmethacrylate (BMA).

13. A tracer according to claim 10, wherein the fourth unit comprises a thermolabile group for detecting temperature.

14. A tracer according to claim 13, wherein the fourth unit comprises a nitrile or peroxide thermolabile group.

15. A tracer according to claim 1, having general formula (I): 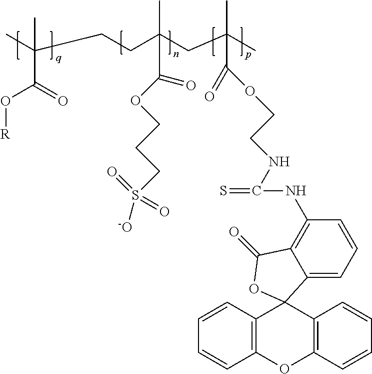
in which:
q is the number of lipophilic units,
n is the number of hydrophilic and negative units,
p is the number of fluorescent detectable units,
R is selected from CH3-, CH2CH2CH2CH3-, CH2CH2OH—;
or having general formula (II): 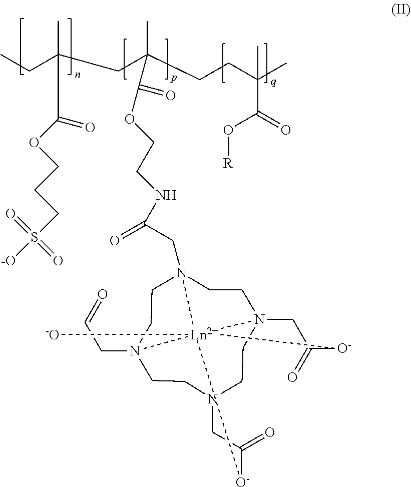
in which:
q is the number of lipophilic units,
n is the number of hydrophilic and negative units,
p is the number of detectable units containing a rare earth element,
Ln is a rare earth element selected from the group consisting of yttrium, scandium and lanthanides.

16. A tracer according to claim 1, having general formula (III): 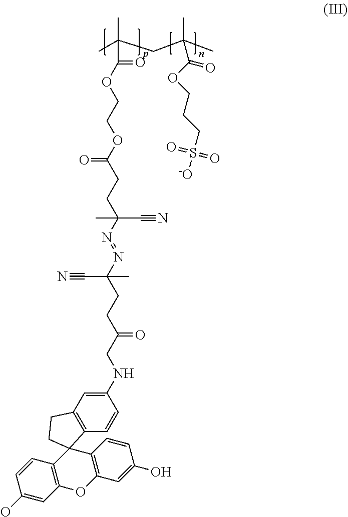
in which:
n is the number of hydrophilic and negative units,
p is the number of detectable units functionalized with thermolabile groups.

17. A method for analysing an oilfield, in particular for mapping and characterizing the oilfield, comprising injecting the tracer of claim 1 during a waterflooding operation of the oilfield.

18. (canceled)

19. Process for synthesizing a multifunctional tracer according to claim 1, wherein the plurality of units take part in a free radical polymerization reaction in solution which close with formation of a multifunctional copolymer defining the tracer.

20. A process according to claim 19, further comprising a step of synthesis of a detectable co-monomer, defining the second unit of the tracer and subsequently a step of polymerization of all the monomers and/or co-monomers defining the units of the tracers.

21. A process according to claim 20, wherein the step of synthesis of the detectable co-monomer comprises a step of functionalizing a fluorescent molecule with a hydrophilic compound having a vinyl group capable of binding to other units by radical polymerization.

22. A process according to claim 21, wherein the step of synthesis of the detectable co-monomer comprises a step of functionalizing a chelator molecule with a methacrylate molecule to form a functionalized chelator molecule capable of actively take part in the subsequent radical polymerization reaction.

23. A process according to claim 22, wherein the step of synthesis of the detectable co-monomer comprises then a step of chelation of a rare earth element with the functionalized chelator molecule.
